(19) United States
(12) Patent Application Publication
(10) Pub. No.: US 2002/0114741 A1
(43) Pub. Date: Aug. 22, 2002

(54) Adhesive label for microcentrifuge tube

(75) Inventor: Daniel Perlman, Arlington, MA (US)

Correspondence Address: Wesley B . Ames, Foley & Larder, 402 W. Broadway, 23rd floor, San Diego, CA, 92101, US

(73) Assignee: Brandeis University

(21) Appl. No.: 09/788,337

(22) Filed: Feb. 16, 2001

(51) Int. Cl. B01L 3/00

(52) U.S. Cl. 422/102; 422/99; 422/72; 422/941; 436/45; 436/174

(57) ABSTRACT

A method for labeling a polyolefin thermoplastic laboratory centrifuge tube which is exposed to boiling water and/or steam, and is centrifuged. The method employs a thin adhesive tape having a facestock material with a markable upper surface and an adhesive-coated lower surface which are all sufficiently resistant to boiling water and steam so that following such exposure, the adhesive tape mounted on the centrifuge tube shows essentially no edge-peeling, and the adhesive has not substantially migrated. Following centrifugation in a centrifuge rotor, the centrifuge tube is freely removable and not adhered within the rotor. The method includes the steps of:

(i) providing a portion of the adhesive tape sized to fit the tube,

(ii) marking the upper surface of the adhesive tape to identify a sample placed in the centrifuge tube, and

(iii) attaching the adhesive tape to the centrifuge tube.

### BACKGROUND OF THE INVENTION

This invention relates to use of adhesive labels on centrifuge tubes.

Microcentrifuge tubes (also known as microtubes) are small thermoplastic tubes which are typically conical or tapered and closed at one end. Microtubes capable of holding approximately 0.2-2.5 ml of liquid, are usually fabricated from polyethylene or polypropylene (polyolefin) and formed by an injection-molding process. Microtubes are generally sealed with a tight-fitting frictionally-seated hinged lid or a screw-cap type lid which helps maintain the inside of the tube in an aseptic condition. For purposes of centrifugation, microtubes are commonly constructed to withstand forces in excess of 10,000 times their own weight and are sized to fit into round holes in metal or plastic rotors which are rotated at high speed. A microtube is generally suspended in a centrifuge rotor hole by an integrally molded plastic flange located near the lip of the tube. Examples of such tubes are described and advertised for sale in the current 1994-1995 scientific apparatus catalogs published by VWR Scientific (pp. 247-251) and Thomas Scientific (pp. 265-269) hereby incorporated by reference. It is common practice to utilize microtubes as sample vessels for carrying out chemical and biochemical reactions in the laboratory, and to incubate these microtubes in chambers and baths under a wide variety of conditions ranging from cold air environments (e.g., −70° C., −20° C. in freezers) to ice baths at 0° C., and hot water and steam environments (e.g., 100° C.-121° C. in boiling water baths and autoclaves). High temperature incubations of laboratory samples in microtubes may be utilized for disolving solids in liquids, denaturing biochemical materials, and inactivating certain enzymes whose activities are no longer desirable. It is also common practice to centrifuge and fractionate these incubated samples in microtubes utilizing a microcentrifuge and rotor for holding the microtubes .

Asa and Asa, U.S. Pat. No. 4,674,640 describe the design of a new plastic microtube cap having a flat top surface with a roughened texture to facilitate such marking. In discussion of the prior art, Asa and Asa point out:

“The problem with the prior art is that it has been impossible to conveniently write on a centrifuge tube in a consistent manner to identify it. The sides of the tube, which is [sic.] made out of polypropylene, are inherently slick because of the properties of the material, and are sharply curved because of the small diameter of the tube, and as a result are difficult to write on.”

They continue by discussing the use of adhesive tags placed on the top or side of the microtube and point out that the irregularity of a tag not properly secured to the side of the tube can make it difficult to insert or remove the tube from a holding rack, and conclude, “None of these tags prove to be a satisfactory solution to marking the tubes.”

### SUMMARY OF THE INVENTION

This invention concerns use of thin markable labels which, when adhered to polyolefin thermoplastic centrifuge tubes and submerged in boiling water or autoclaved, continue to be so adhered without label edge curling, peeling, or substantial migration of the adhesive occurring, any of which would cause undesirable adhesion of the tubes in a centrifuge rotor.

Applicant has discovered a thin and very durable adhesive tape material which can serve as a markable label on polyolefin, i.e., polyethylene and polypropylene centrifuge tubes which must withstand incubation in boiling water and/or steam autoclaving prior to centrifugation in a centrifuge rotor. In this use involving heat and moisture contact, the adhesive which binds the label to the centrifuge tube must remain in its original location so that the outer surfaces of the tube and label remain free of adhesive, i.e., non-tacky. In this manner the labelled tube remains freely removable and does not become adhered within the rotor. Therefore the facestock and the adhesive of the label must be resistant to boiling water and steam, and must remain cooperatively bound to one another and to the centrifuge tube surface in these high temperature aqueous environments (to avoid migration of the adhesive and curling or peeling of the edge of the label). Furthermore, the overall thickness of the tape must be limited so that when the tape is wrapped once around the circumference of the microtube, it does not cause jamming of the tube in the centrifuge rotor. Accordingly, Applicant has determined that the thickness of the tape should be less than 0.005 inches.

Thus, in a first aspect, the invention features a method for labeling a laboratory polyolefinic centrifuge tube which is exposed to boiling water and/or steam for at least 1 minute, and preferably for 5 minutes, and is then centrifuged. A thin (less than 0.005 inch), sized portion of adhesive tape which includes a facestock material (with a markable upper surface and an adhesive-coated lower surface) is marked (before or after attachment) and attached to the sidewall portion of the centrifuge tube to produce a “labelled tube”. The method includes the steps of providing an adhesive tape in which the facestock and adhesive of the tape are sufficiently resistant to boiling water and steam so that following contact with boiling water and/or steam, the adhesive coating on the adhesive tape remains bound to both the tape and the tube, and the tape shows essentially no edge-peeling (as viewed by eye). Also, the adhesive coating shows no substantial migration (as viewed by eye) from its original location between the lower surface of the adhesive tape and the sidewall portion of the centrifuge tube. [Those in the art will recognize that the specific tape example provided below also provides an example of what is meant by essentially no edge-peeling, and no substantial migration.] A sized portion of this adhesive tape is attached to a centrifuge tube, and following manipulation of the labelled tube, including centrifugation and centrifugal force-compression of the adhesive tape on the centrifuge tube in the centrifuge rotor, the labelled tube is freely removable and not adhered or jammed within the centrifuge rotor.

In a second aspect, the invention features a laboratory polyolefinic centrifuge tube adapted for incubation in boiling water and/or steam autoclaving, followed by centrifugation. The centrifuge tube includes a thin adhesive label attached to the sidewall of the tube. The label is composed of a facestock material with a markable upper surface and an adhesive-coated lower surface. The facestock and adhesive of the label, as well as the tube are sufficiently resistant to boiling water and steam so that following contact with boiling water and/or steam, the label on the centrifuge tube shows essentially no edge-peeling, and the adhesive coating does not substantially migrate from its original location. Consequently, following centrifugation in a centrifuge rotor, and centrifugal force-compression of the adhesive label on the centrifuge tube in the rotor, the centrifuge tube remains freely removable and not adhered within the rotor.

In preferred embodiments of the above aspects, the thermoplastic centrifuge tube is a microcentrifuge tube capable of holding between approximately 0.2 and 2.5 milliliters of liquid; the centrifuge tube is formed from either polyethylene or polypropylene polyolefinic thermoplastic; the sized portion of adhesive tape is between approximately 0.25 and 1.0 inches wide and between approximately 0.5 and 2.0 inches long; the sized portion of adhesive tape is provided on a disposable release paper liner as a pre-cut peel-off label in identically sized repeating units; the overall thickness of the adhesive tape is less than the gap space or clearance between the centrifuge tube and the wall of the rotor hole measured as the centrifuge tube rests in said rotor hole; preferably the overall thickness of the adhesive tape ranges between approximately 0.001 and 0.005 inches; most preferably the tape thickness ranges between approximately 0.002 and 0.004 inches; the facestock material of the adhesive tape includes a polyester material and/or a polyvinyl material; when the facestock material includes a polyester material, the markable upper surface has a matte finish to improve markability; the facestock material is translucent, transparent, or opaque; the adhesive coating on the lower surface of the adhesive tape includes an acrylic permanent adhesive; the adhesive tape, or adhesive tape with a permanent acrylic-type adhesive adhered to a polypropylene surface has an initial 180 degree peel strength (based upon ASTM testing method 3330) of at least 25 ounces per inch.

Having demonstrated that it is possible to find a useful adhesive material, those in the art can readily find equivalent materials having the functional design features described herein. These design features are reflected in the thickness and adhesive properties described herein.

Other features and advantages of the invention will be apparent from the following description of the preferred embodiments thereof, and from the claims.

### DESCRIPTION OF THE PREFERRED EMBODIMENT

Prior to discoveries made in the present invention, Applicant attempted to label the tops and sides of polyethylene and polypropylene microtubes utilizing a variety of different marking labels and tape products such as Time Tape® (TimeMed Labeling Systems, Inc., Burr Ridge, Ill.) manufactured for laboratory use. The problems described by Asa and Asa, U.S. Pat. No 4,674,640 were replicated and were particularly severe when attempting to incubate labelled microtubes in boiling water baths and subsequently attempting to centrifuge these same microtubes. In Applicant's experience, boiling water and/or autoclave steam tended to soften and infiltrate such labels and adhesives with the resulting peeling of the label, exposure of adhesive at the edge of the label, outward migration of adhesive from beneath the label, or some combination of these problems. When any one of these events occurs on a microtube carrying a sidewall label, and the microtube is then placed in a storage rack or in a centrifuge rotor, the microtube and label tend to become jammed or adhered in the rack or rotor. This phenomenon has proven inconvenient at best and has resulted in the loss and mix-up of sample identifying markings on microtubes. Although manufacturers of adhesive tapes (e.g., 3M Industrial Specialties Division, 3M Corporation, St. Paul, Minn.) often provide information on a tape's resistance to humidity at ambient temperatures and its resistance to elevated temperature (dry heat), information is not generally available on the resistance of a tape product to boiling water. Applicant empirically tested many candidate adhesives and facestock materials to find a tape material which, when adhered to polypropylene, did not peel in boiling water.

In considering the possible use of a laboratory tape such as Time Tape® for labeling a polyolefinic microtube, the thickness of the tape (0.005 inches) may pose an additional problem. Applicant has determined that the radial clearance between most commercially manufactured microtubes and the cylindrical rotor holes in commercial microcentrifuge rotors is typically 0.005 inches or less. Thus, a single thickness of Time Tape® placed around a microtube, in adding 0.005 inches to the radius of the microtube, can exclude the tube from the rotor or jam the tube.

In general, the invention features the use of a specialized, thin markable, permanent-adhesive style labelling tape which is capable of remaining entirely adhered (without any tape edge curling or migration of adhesive) to a thermoplastic centrifuge tube (typically a polyolefinic resin tube-either polyethylene or polypropylene) even after the labelled tube has been immersed in boiling water (generally 10-20 minutes) and steam-autoclaved (20 psi steam pressure, 121° C.), so that when the tube is centrifuged it does no become cemented, adhered, or otherwise jammed in the centrifuge rotor. That is, following boiling, the labelled centrifuge remains freely insertable into the rotor and freely removable following centrifugation. When conventional markable laboratory tapes are applied to typical commercial polypropylene microtubes and boiled, they either separate from the tube, exhibit edge-curl (preventing insertion into the rotor), or they allow outward migration of the adhesive, causing the outside of the tape and tube to become sticky. When such labelled tubes are placed into a rotor and centrifuged, the force exerted on the sticky tape often causes the tube to become adhered to the inside of the rotor cavity or hole. Even if the jammed tube can be pulled free, any jerking force or time delay in tube manipulation is often sufficient for a sedimented specimen to be partially or completely dislodged from the tube wall and partially or completely lost. Thus for optimal centrifugation and sample recovery, it is important that a centrifuge tube carrying an adhesive label on its sidewall always remain freely removable from the rotor. This is especially critical after a labelled centrifuge tube has been immersed in boiling water or steam-autoclaved and the adhesive has had an opportunity to soften and migrate, or the water has had an opportunity to infiltrate the junction between the tape and tube and by loosening the tape, allow the edge(s) to curl and reveal adhesive. Such tubes often become jammed in centrifuge rotors. In a related matter, Applicant has determined that the spacial clearance between microtubes and the inner walls of microcentrifuge rotor holes which receive these microtubes is limited. Typical commercial rotors holding commercial polypropylene microtubes for example, often exhibit no more than 0.005 inches of radial clearance around each tube. Accordingly, common labelling tapes of comparable thickness tend to jam the microtubes in rotors. In the present invention, thinner specialized tapes have been discovered which possess the other required properties as well, with regard to adhesion to polyolefin resins, in the presence of heat and moisture. For example, tapes having an overall thickness of between 0.002 and 0.004 inches, including markable (preferably matte finished) polyester and markable polyvinyl facestock materials which were combined with any one of several different acrylic or rubber-based adhesives, have been characterized for adhesion to polypropylene microtubes. These tapes and tubes were immersed for varying time intervals in boiling water or pressurized steam. It was found that that most adhesives could not anchor the tapes to a polypropylene microtube without some peeling occurring. However, at least two polyester tapes with acrylic adhesive, and possessing an initial 180 degree peel strength of greater than 20 ounces per inch (measured on a polypropylene surface) succeeded in such anchoring without peeling. In testing three acrylic adhesives manufactured by the 3M Corporation (#200 “Hi-Performance”, #300 “Hi-Strength, and #400 “Hi-Tack” adhesive), only the #300 adhesive prevented peeling of a polyester facestock tape remained attached to a polypropylene centrifuge tube when it was immersed in boiling water for five minutes. This adhesive, when applied to a polyester facestock tape, provides an initial 180 degree peel strength (ASTM 3330 procedure) of approximately 50 ounces per inch. At present, it is not fully understood why one acrylic adhesive works in the present invention while another fails to be useful. Two commercial polyester tape products incorporating the #300 adhesive are manufactured by the 3M Corporation and are cataloged as Products 7880 and 7881. The former is a matte-finished white tape and the latter is a similarly finished clear tape. Each includes a 0.0025 inch thick polyester facestock tape combined with an approximately 0.001 inch thick #300 acrylic adhesive coating, producing an adhesive tape having an overall thickness of approximately 0.0035 inches. Each of these products can be purchased in roll form on a non-stick release paper liner (e.g. a Kraft-type release paper approximately 0.003 inches thick) which allows serial die-cutting or butt-cutting of the stock material, to generate conveniently usable, identically sized multiple peel-off labels.

The selection of a polyester facestock label and acrylic adhesive (such as 3M Corporation Products 7880 and 7881) described above represents a preferred embodiment of the invention because the materials are compatible with, and resistant to many of the diverse environmental conditions encountered in the course of handling microtubes. In addition to contact with boiling water, these conditions include autoclave-steam sterilization, incubation and storage of microtubes in low temperature freezers (−70° C.), and inadvertant contact with traces of organic solvents and caustic agents (being placed inside the microtubes). For convenience of use, the matte finish as provided with the 3M products listed above, allows sample identification marking of the tape using almost any writing or printing instrument including pencil, ballpoint pen, ink pen, permanent waterproof marker, and computer dot matrix,bubble jet and laser printers. Furthermore, the selection of a polyester-based tape provides abrasion and scuff resistance as well as resistance to tearing. These features are important when microtubes carrying samples are shaken, or otherwise agitated or moved against hard surfaces such as holding racks. Under these conditions it is essential that sample markings are not altered or removed by scuffing. For label placement on a tube, positional adjustment, or removal of the label from a tube, the resistance of polyester tape to tearing is also useful.

With regard to the method of use of the present invention, the upper surface of the above-described adhesive tape (which preferably has been sized and precut to fit a centrifuge tube) is marked to identify a particular sample placed in the polyolefin centrifuge tube. This tape may be adhesively attached to the sidewall of the centrifuge tube (to provide a labelled centrifuge tube) which can then be incubated in a boiling water bath or steam-autoclaved, and subsequently centrifuged. Following centrifugation, the labelled centrifuge tube is freely removable from the centrifuge rotor because the label is still tightly adhered to the tube and has not peeled or become sticky or jammed in the centrifuge rotor.

Other embodiments of the present invention are within the following claims.

1. Method for labeling a polyolefin thermoplastic laboratory centrifuge tube which is exposed to boiling water and/or steam, and is centrifuged, said method comprising the steps of:
providing a thin, sized portion of adhesive tape comprising a facestock material with a markable upper surface and an adhesive-coated lower surface,wherein the facestock and adhesive of said adhesive tape are sufficiently resistant to boiling water and steam for 5 minutes so that following contact with boiling water and/or steam, said adhesive tape on said centrifuge tube shows no edge-peeling, and said adhesive coating does not migrate from its original location between said lower surface of said adhesive tape and said sidewall portion of said centrifuge tube,
attaching said sized portion of adhesive tape to the sidewall portion of said centrifuge tube thereby providing a labelled tube, wherein following boiling water-heating of said centrifuge tube, centrifugation in a centrifuge rotor and centrifugal force-compression of said adhesive tape on said centrifuge tube in said rotor, said labelled tube is freely removable and not adhered within said rotor, and
before or after said attaching step, marking said upper surface to identify a sample placed in said centrifuge tube.

2. The method of claim 1, wherein said centrifuge tube is a microcentrifuge tube capable of holding between approximately 0.2 and 2.5 milliliters of liquid.

3. The method of-claim 1, wherein said sized portion of adhesive tape is between approximately 0.25 and 1.0 inches wide and between approximately 0.5 and 2.0 inches long.

4. The method of claim 1, wherein said sized portion of adhesive tape is provided on a disposable release paper liner as a pre-cut peel-off label in identically repeated units.

5. The method of claim 1, wherein the overall thickness of said adhesive tape is less than the circular gap space or clearance between said centrifuge tube and said rotor hole measured as said centrifuge tube rests in said rotor hole.

6. The method of claim 1, wherein the overall thickness of said thin, sized adhesive tape ranges between approximately 0.001 and 0.005 inches.

7. The method of claim 6, wherein said thickness ranges between approximately 0.002 and 0.004 inches.

8. The method of claim 1, wherein said facestock material comprises a polyester material and/or a polyvinyl material.

9. The method of claim 1, wherein said facestock material comprises a polyester material and said markable upper surface has a matte finish to improve markability.

10. The method of claim 1, wherein said facestock material is translucent or transparent.

11. The method of claim 1, wherein said facestock material is opaque.

12. The method of claim 1, wherein the adhesive coating on said lower surface of said adhesive tape comprises an acrylic-type permanent adhesive.

13. The method of claim 1 or claim 12, wherein the initial 180 degree peel strength of said adhesive tape on a polypropylene surface is at least 25 ounces per inch.

14. The method of claim 1, wherein said centrifuge tube is formed from polyethylene or polypropylene polyolefin thermoplastic.

15. A polyolefin thermoplastic laboratory centrifuge tube adapted for incubation in boiling water and/or steam followed by centrifugation, said centrifuge tube comprising a thin adhesive label attached to the sidewall of said centrifuge tube, said label comprising a facestock material with a markable upper surface and an adhesive-coated lower surface, wherein the facestock and adhesive of said label, in addition to said tube, are sufficiently resistant to boiling water and steam so that following contact with boiling water and/or steam, said label on said centrifuge tube shows no edge-peeling, and said adhesive coating does not migrate from its original location on said lower surface and, following centrifugation in a centrifuge rotor, and centrifugal force-compression of said adhesive label on said centrifuge tube in said rotor, said centrifuge tube is freely removable and not adhered within said rotor.
